(19) United States
(12) Patent Application Publication
(10) Pub. No.: US 2018/0089728 A1
(43) Pub. Date: Mar. 29, 2018

(54) SYSTEM AND METHOD FOR STREAMING MEDIA PLAYER PRE-CONFIGURATION

(71) Applicant: BOSE CORPORATION, Framingham, MA (US)

(72) Inventors: Glenn Gomes-Casseres, Newton, MA (US); Santiago Carvajal, Ashland, MA (US); Michael Leonard Angelo, Framingham, MA (US)

(21) Appl. No.: 15/277,741

(22) Filed: Sep. 27, 2016

(51) Int. Cl. G06Q 30/06; G06F 3/16

(52) U.S. Cl. CPC G06Q 30/0601; G06F 3/165

(57) ABSTRACT

A method comprises receiving, at a computer system of a retailer, a request from a gift giver to purchase a streaming music player for a gift recipient, presenting the gift giver with a list of streaming audio channels, receiving, at the computer system of the retailer, a selection by the gift giver of one or more streaming audio channels from the list of streaming audio channels to assign to one or more respective preset selectors of the streaming music player, and assigning the one or more streaming audio channels to the one or more respective preset selectors of the streaming music player during setup of the streaming music player by the gift recipient.

### TECHNICAL FIELD

Aspects and implementations of the present disclosure are directed generally to streaming media player devices and specifically to systems and methods for preconfiguring preset channels of same to personalized settings.

### BACKGROUND

Streaming media players, for example, streaming music players allow a user to access and stream content from external sources, for example, from internet radio stations or other internet-based streaming media service providers. Some streaming music players include functionality for storing preset or favorite channels or stations such that a user may access a favorite channel or station by, for example, actuating an button or other feature associated with the favorite channel on the streaming music player or on a controller for the streaming music player. The user sets the preset channels or stations after the streaming music player has been purchased and set up.

SUMMARY

In accordance with an aspect of the present disclosure, there is provided a computer system comprising a processor and a non-transitory computer readable memory including instructions that when executed by the processor cause the computer system to receive a request from a gift giver to purchase a streaming music player for a gift recipient, present the gift giver with at least one streaming audio channel, receive a selection by the gift giver of one or more streaming audio channels to assign to one or more respective preset selectors of the streaming music player, and send instructions to assign the one or more streaming audio channels to the one or more respective preset selectors of the streaming music player, based on the selection received from the gift giver.

In some implementations, the instructions, when executed by the processor, further cause the computer system to receive a request from the gift giver to purchase a streaming music service subscription for use with the streaming music player for the gift receiver, and request that a streaming music service provider add a duration of the streaming music service subscription to an streaming music service subscription of the gift receiver.

In some implementations, the instructions, when executed by the processor, further cause the computer system to receive demographic information regarding the gift receiver and to instruct a streaming music service provider of a streaming music service associated with the streaming music service subscription to provide recommended streaming audio channels in the list of streaming audio channels, the recommended streaming audio channels selected based on the demographic information regarding the gift receiver.

In some implementations, the instructions, when executed by the processor, further cause the computer system to present the gift giver with a list of streaming audio channels by identifying a source of streaming audio channels, and presenting a listing of streaming audio channels from the source of streaming audio channels in a composite web page having a look and feel of a host web page of the retailer.

In some implementations, the instructions, when executed by the processor, further cause the computer system to present a plurality of visibly perceptible elements in the composite web page. The plurality of visibly perceptible elements may be substantially similar to a plurality of visibly perceptible elements presented on the host web page of the retailer.

In some implementations, the instructions, when executed by the processor, further cause the computer system to receive an indication from the gift giver of an age and a gender of the gift receiver and to create a retailer account for the gift receiver including an indication of the age of the gift receiver and an indication of the gender of the gift receiver.

In some implementations, the instructions, when executed by the processor, further cause the computer system to include an indication of the one or more streaming audio channels selected by the gift giver in the retailer account for the gift receiver.

In some implementations, the streaming music player is configured to assign the one or more streaming audio channels to the one or more respective preset selectors by a method including accessing the indication of the one or more streaming audio channels selected by the gift giver in the retailer account for the gift receiver. In some implementations, the computer system is further configured to receive an indication of a unique identifier of the streaming music player and add the unique identifier to a retailer account of the gift receiver. The unique identifier may be a serial number of the streaming music player.

In some implementations, the instructions, when executed by the processor, further cause the computer system to receive a request from the gift giver to purchase a streaming music service subscription for use with the streaming music player for the gift receiver, and request that a streaming music service provider create a streaming music service subscription for the gift receiver.

In accordance with another aspect, there is provided a method comprising receiving, at a computer system of a retailer, a request from a gift giver to purchase a streaming music player for a gift recipient, sending a list of streaming audio channels to the gift giver, receiving, at the computer system of the retailer, a selection by the gift giver of one or more streaming audio channels from the list of streaming audio channels to assign to one or more respective preset selectors of the streaming music player, and sending instructions to assign the one or more streaming audio channels to the one or more respective preset selectors of the streaming music player.

In some implementations, the method further comprises receiving, at the computer system of the retailer, a request from the gift giver to purchase a streaming music service subscription for use with the streaming music player for the gift receiver.

In some implementations, the method further comprises requesting that a streaming music service provider of a streaming music service associated with the streaming music service subscription add a duration of the streaming music service subscription to an existing streaming music service subscription of the gift receiver.

In some implementations, the method further comprises receiving, at the computer system of the retailer, demographic information regarding the gift receiver and instructing a streaming music service provider of a streaming music service associated with the streaming music service subscription to provide recommended streaming audio channels in the list of streaming audio channels. The recommended streaming audio channels may be selected based on the demographic information regarding the gift receiver.

In some implementations, presenting the gift giver with the list of streaming audio channels comprises identifying a source of streaming audio channels, and presenting a listing of streaming audio channels from the source of streaming audio channels in a composite web page having a look and feel of a host web page of the retailer.

In some implementations, the method further comprises presenting a plurality of visibly perceptible elements in the composite web page, the plurality of visibly perceptible elements being substantially similar to a plurality of visibly perceptible elements presented on the host web page of the retailer.

In some implementations, the method further comprises receiving, at the computer system of the retailer, an indication from the gift giver of an age and a gender of the gift receiver and creating a retailer account for the gift receiver including an indication of the age of the gift receiver and an indication of the gender of the gift receiver.

In some implementations, the method further comprises including an indication of the one or more streaming audio channels selected by the gift giver in the retailer account for the gift receiver.

In some implementations, assigning the one or more streaming audio channels to the one or more respective preset selectors of the streaming music player includes the streaming music player accessing the indication of the one or more streaming audio channels selected by the gift giver in the retailer account for the gift receiver.

In some implementations, the streaming music player identifies the retailer account for the gift receiver by matching a unique identifier of the streaming music player with an indication of a unique identifier included in the retailer account for the gift receiver.

In accordance with another aspect, there is provided a streaming music player. The streaming music player comprises a processor, a network interface operatively coupled to the processor and configured to access streaming audio content from one or more streaming audio content sources, an electro-acoustic transducer operatively coupled to the processor, a plurality of preset indicators operatively coupled to the processor, each of the plurality of preset indicators configured to initiate streaming and rendering of content from an assigned audio channel from one of the streaming audio content sources through the electro-acoustic transducer, and a memory operatively coupled to the processor. The memory includes programming which when executed by the processor causes the processor to access a cloud-based database including account information associated with the streaming music player including a set of user-defined audio channel presets associated with a unique identifier of the streaming music player and to assign the user-defined audio channel presets to the plurality of preset indicators.

In some implementations, the plurality of preset indicators are presented on one of a remote control for the streaming music player or a computing device running an application associated with the streaming music player.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A is a perspective view of an exemplary streaming music player;

FIG. 1B is a top plan view of the streaming music player of FIG. 1A;

FIG. 1C is a block diagram of the streaming music player of FIG. 1A;

FIG. 2A is a first portion of a flow chart of a method for a gift giver to purchase a streaming music player for a gift recipient;

FIG. 2B is a second portion of the flowchart of FIG. 2A;

FIG. 3 is a flow chart of a method of fulfilling an order for a streaming music player;

FIG. 4A is a first portion of a flowchart of a method for setting up a streaming music player by a gift recipient;

FIG. 4B is a second portion of the flow chart of FIG. 4A;

FIG. 5 illustrates an environment in which aspects and implementations disclosed herein may be practiced; and

FIG. 6 illustrates a computer system upon which aspects of methods disclosed herein may be performed.

### DETAILED DESCRIPTION

Aspects and implementations disclosed herein are not limited to the details of construction and the arrangement of components set forth in the following description or illustrated in the drawings. Aspects and implementations disclosed herein are capable of being practiced or of being carried out in various ways.

Aspects and implementations disclosed herein are generally directed to systems and methods for a first user, a gift giver, to preconfigure preset stations or channels on a streaming music player to be gifted to a recipient. The terms “stations” and “channels” are used interchangeably herein and encompass internet radio channels, playlists from internet streaming services, or other pre-defined locations or access points for accessing streaming music. Although referred to herein as a “streaming music player,” it is to be understood that the disclosed streaming music player may be utilized to stream audio content other than music. When the gift recipient unboxes and sets up the streaming music player, it is configured and personalized with presets that the gift giver believed that the gift recipient would enjoy. The systems and methods disclosed herein may eliminate some of the steps that the gift recipient would otherwise perform to set up the streaming music player.

The systems and methods disclosed herein may also allow the gift giver to make the streaming music player a more personal gift by tailoring the presets just for the gift recipient.

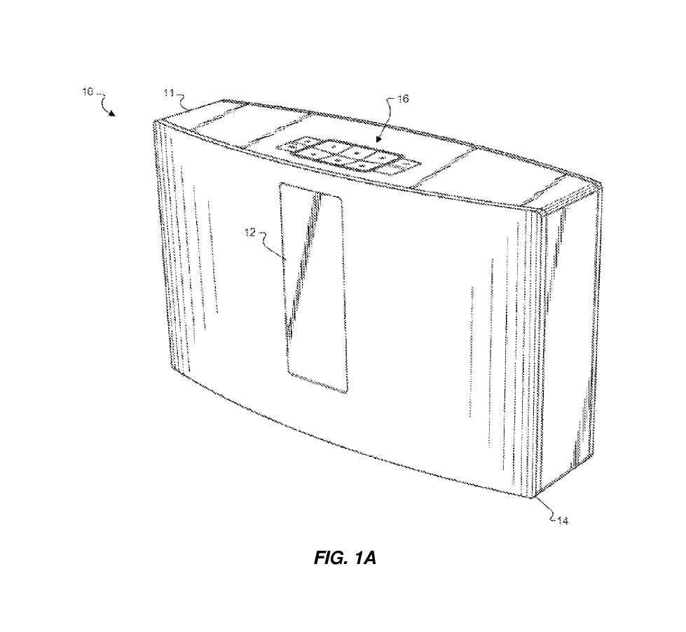

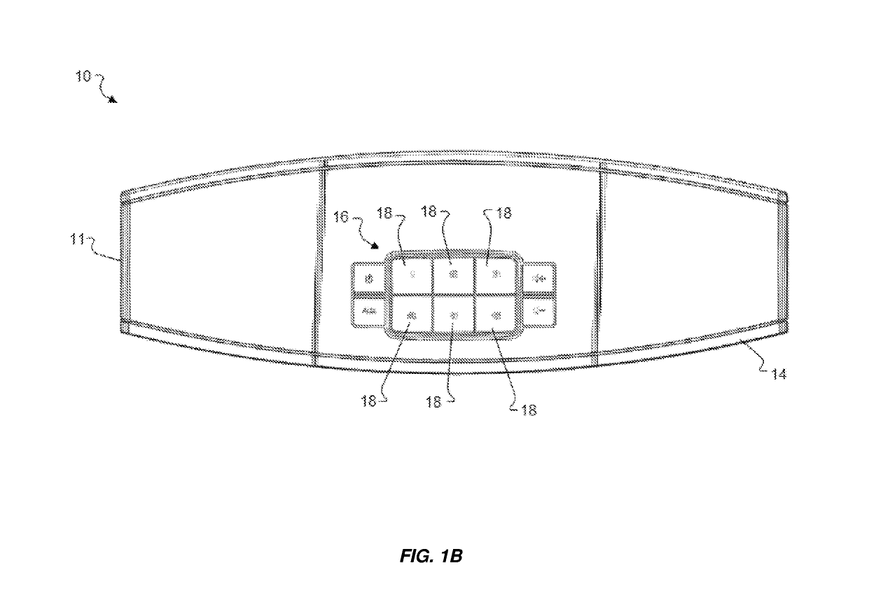

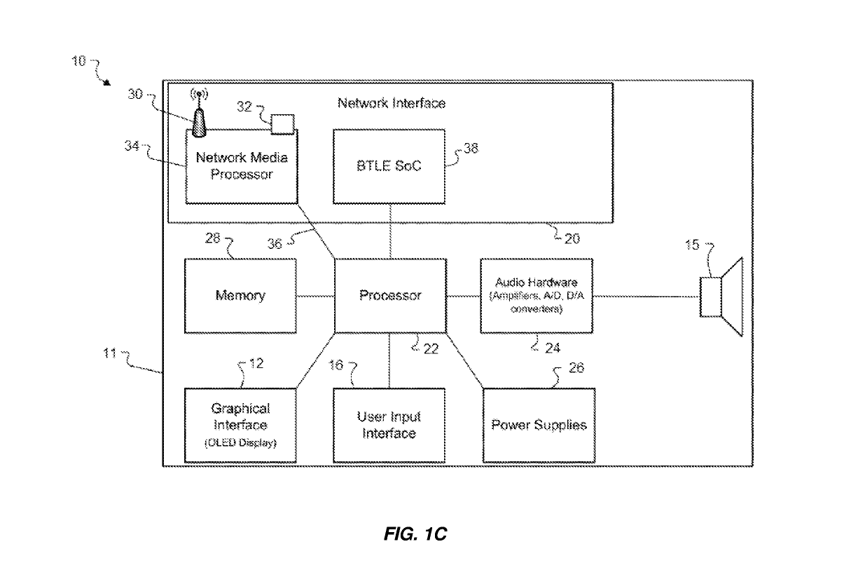

The aspects and implementations disclosed herein are generally applicable to any one of multiple streaming music players. In one particular implementation, the streaming music player is one of the SoundTouch® audio playback devices available from the Bose Corporation. An example of such a system is illustrated in FIGS. 1A-1C. This device is described in co-owned U.S. Pat. No. 9,330,169 “AUDIO SYSTEMS AND RELATED DEVICES AND METHODS,” which is incorporated herein in by reference its entirety for all purposes.

Referring to FIG. 1A, the audio playback device 10 includes an enclosure 11 and on the enclosure 11 there resides a graphical interface 12 (e.g., an OLED display) which can provide a user with information regarding currently playing (“Now Playing”) music and information regarding the presets. A screen 14 conceals one or more electro-acoustic transducers 15 (FIG. 1C). The audio playback device 10 also includes a user input interface 16. As shown in FIG. 1B, the user input interface 16 includes a plurality of preset indicators 18, which are hardware buttons in the illustrated example. The preset indicators 18 (numbered 1-6) provide the user with easy, one press access to entities assigned to those buttons. That is, a single press of a selected one of the preset indicators 18 will initiate streaming and rendering of content from the assigned entity.

The assigned entities can be associated with different digital audio sources, for example, stations, channels, or playlists from internet radio stations or streaming music services such as the Pandora®, Spotify®, vTuner®, iHeartRadio®, Deezer®, SiriusXM®, Amazon Music, etc. services. A single audio playback device 10 can provide for single press access to various different digital audio sources. In one example, the assigned entities include at least (i) user-defined playlists of digital music and (ii) Internet radio stations. In another example, the digital audio sources include a plurality of Internet radio sites, and the assigned entities include individual radio stations provided by those Internet radio sites.

Notably, the preset indicators 18 operate in the same manner, at least from the user's perspective, regardless of which entities are assigned and which of the digital audio sources provide the assigned entities. That is, each preset indicator 18 can provide for single press access to its assigned entity whether that entity is a user-defined playlist of digital music provided by a network attached storage (NAS) device or an Internet radio station provided by an Internet music service.

With reference to FIG. 1C, the audio playback device 10 also includes a network interface 20, a processor 22, audio hardware 24, power supplies 26 for powering the various audio playback device components, and memory 28. Each of the processor 22, the graphical interface 12, the network interface 20, the audio hardware 24, the power supplies 26, and the memory 28 are interconnected using various buses, and several of the components may be mounted on a common motherboard or in other manners as appropriate.

The network interface 20 provides for communication between the audio playback device 10 and a controller (for example, a remote control or a smart phone or computer having an appropriate control application installed), a server connected to the internet or cloud-based server that may contain an account database including information regarding an audio system account of a user, audio sources, and other audio playback devices 10 via one or more communications protocols. The network interface 20 may provide either or both of a wireless interface 30 and a wired interface 32. The wireless interface 30 allows the audio playback device 10 to communicate wirelessly with other devices in accordance with a communication protocol such as such as IEEE 802.11b/g. The wired interface 32 provides network interface functions via a wired (e.g., Ethernet) connection.

In some examples, the network interface 20 may also include a network media processor 34 for supporting Apple AirPlay® (a proprietary protocol stack/suite developed by Apple Inc., with headquarters in Cupertino, Calif., that allows wireless streaming of audio, video, and photos, together with related metadata between devices). For example, if a user connects an AirPlay® enabled device, such as an iPhone or iPad device, to a LAN which the audio playback device 10 is in communication with, the user can then stream music to the network connected audio playback devices 10 via Apple AirPlay®. A suitable network media processor is the DM870 processor available from SMSC of Hauppauge, N.Y. The network media processor 34 provides network access (e.g., the Wi-Fi network and/or Ethernet connection can be provided through the network media processor 34) and AirPlay® audio. AirPlay® audio signals are passed to the processor 22, using the I2S protocol (an electrical serial bus interface standard used for connecting digital audio devices), for downstream processing and playback. Notably, the audio playback device 10 can support audio-streaming via AirPlay® and/or DLNA's UPnP protocols, and all integrated within one device.

All other digital audio coming from network packets comes straight from the network media processor 34 through a USB bridge 36 to the processor 22 and runs into the decoders, DSP, and eventually is played back (rendered) via the electro-acoustic transducer(s) 15.

The network interface 11 can also include a Bluetooth low energy (BTLE) system-on-chip (SoC) 738 for Bluetooth low energy applications (e.g., for wireless communication with a Bluetooth enabled controller. A suitable BTLE SoC is the CC2540 available from Texas Instruments, with headquarters in Dallas, Tex.

Streamed data pass from the network interface 20 to the processor 22. The processor 22 can execute instructions within the audio playback device (e.g., for performing, among other things, digital signal processing, decoding, and equalization functions), including instructions stored in the memory 28. The processor 22 may be implemented as a chipset of chips that include separate and multiple analog and digital processors. The processor 22 may provide, for example, for coordination of other components of the audio playback device 10, such as control of user interfaces, or applications run by the audio playback device 10. A suitable processor is the DA921 available from Texas Instruments.

The processor 22 provides a processed digital audio signal to the audio hardware 24 which includes one or more digital-to-analog (D/A) converters for converting the digital audio signal to an analog audio signal. The audio hardware 24 also includes one or more amplifiers which provide amplified analog audio signals to the electroacoustic transducer(s) 15 for playback. In addition, the audio hardware 24 may include circuitry for processing analog input signals to provide digital audio signals for sharing with other devices.

The memory 28 stores information within the audio playback device 10. In this regard, the memory 28 may store account information, such as information regarding the audio station or channel presets. The memory 28 may also provide storage for “tokens” for facilitating single press access to the digital audio sources, for example, internet radio services. A token, as used herein, is a unique identifier that may be provided by a digital audio source and which allows the digital audio source to recognize the audio playback device 10 as being associated with a user's account with the digital audio source and without requiring the user to enter credentials (e.g., user name, password, etc.) each time the audio playback device 10 attempts to access the digital audio source.

The memory 28 may include, for example, flash memory and/or non-volatile random access memory (NVRAM). In some implementations, instructions (e.g., software) are stored in an information carrier. The instructions, when executed by one or more processing devices (e.g., the processor 22), perform one or more processes, such as those described below for retrieving personalized preset information. The instructions can also be stored by one or more storage devices, such as one or more computer- or machine-readable mediums (for example, the memory 28, or memory on the processor). The instructions may include instructions for performing decoding (i.e., the software modules include the audio codecs for decoding the digital audio streams), as well as digital signal processing and equalization. In accordance with some aspects and implementations, the memory 28 includes instructions, that when executed by the processor causes the processor to access a cloud-based database including account information associated with the audio playback device 10 including a set of user-defined audio channel presets and to assign the user-defined audio channel presets to the plurality of preset indicators 18.

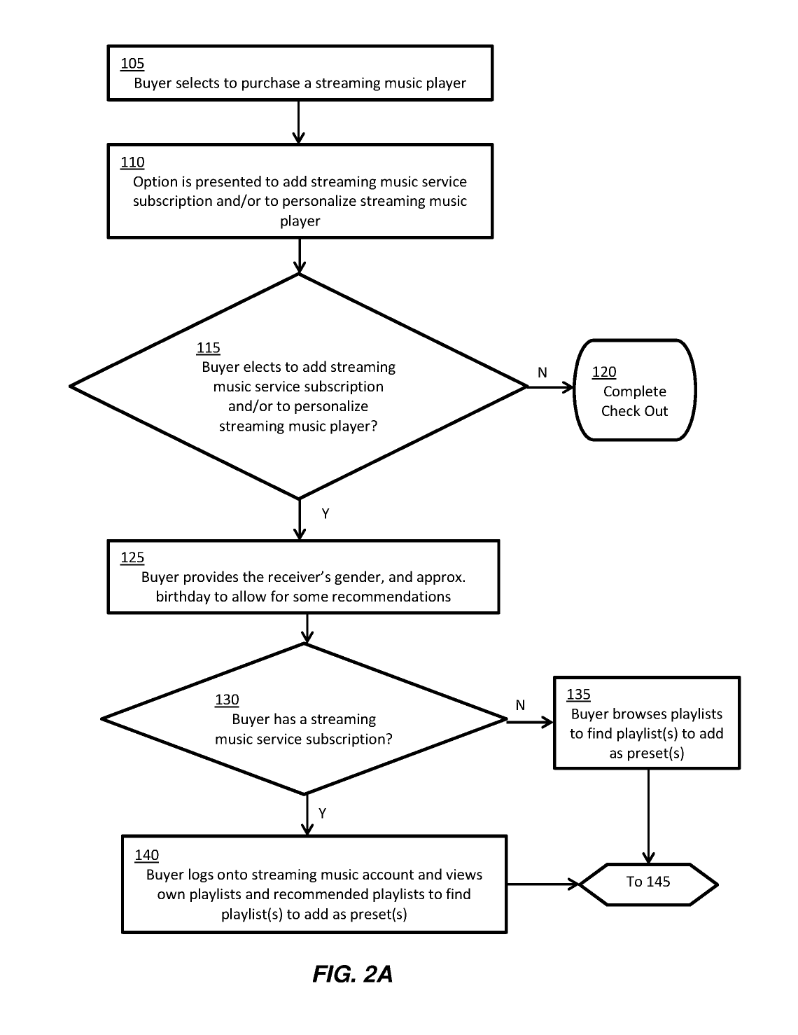

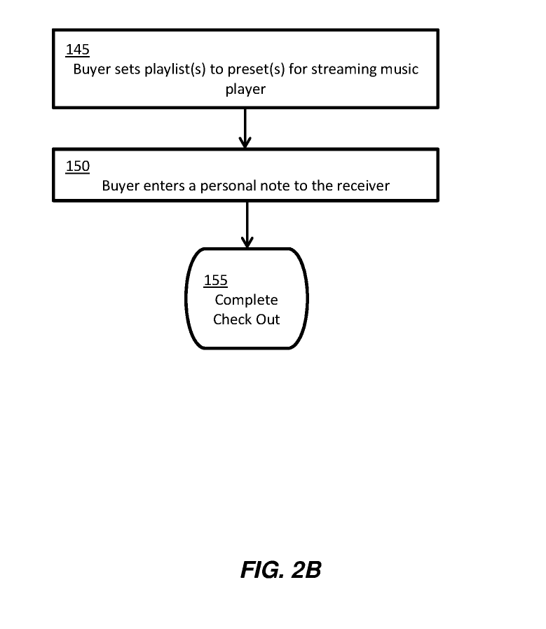

In accordance with some aspects and implementations, there is provided a method for a gift giver to purchase a streaming music player, for example, an audio playback device 10 as described above, for a gift recipient and to define one or more channels or stations to be assigned to the presets of the streaming music player when the streaming music player is set up by the gift recipient. One example of such a method is illustrated in the flowchart of FIGS. 2A and 2B.

In act 105 of the method, a buyer or gift giver selects a streaming music player for purchase as a gift for a gift recipient. The buyer or gift giver may select and purchase the streaming music player over the internet through a website of an audio equipment retailer, for example, through the e-commerce website of the Bose Corporation, Bose.com. During the purchasing process the buyer or gift giver is presented with an option of purchasing a streaming music service subscription for the gift recipient to access streaming audio with the streaming music player. (Act 110.) The streaming music service subscription may be, for example, a 3 month, 6 month, or 12 month subscription to the Spotify® streaming music service. The buyer or gift giver is presented with an option of personalizing the streaming music player by defining what streaming music channels or stations should be assigned as presets on the streaming music player. (Act 110.) If the buyer or gift giver decides not to purchase the streaming music service subscription or to personalize the streaming music player, the buyer or gift giver completes purchase of the streaming music player by proceeding through a checkout process in a conventional manner (Acts 115, 120.)

If the buyer or gift giver decides to purchase the streaming music service subscription or to personalize the streaming music player (act 115), the buyer or gift giver provides information regarding the intended gift recipient, for example, the intended recipient's name, e-mail address, gender, approximate or exact age or birthday, location, and/or other demographic information about the intended gift recipient. (Act 125.) This information may be supplied by the buyer or gift giver through, for example, a form on the web site though which the buyer or gift giver is purchasing the streaming music player. Some of the information about the intended gift recipient may be required and some may be optional. In some implementations, this information may be used to provide recommendations for audio channels or stations that the intended gift recipient is likely to enjoy.

The buyer or gift giver proceeds to personalize the streaming music player for the intended gift recipient by assigning one or more streaming music channels or stations as presets on the streaming music player. If the buyer or gift giver does not have an account with a streaming music service, the buyer or gift giver may be presented with a list of streaming music services to select from, and may browse preconfigured playlists, stations, or channels from one or more of the streaming music services and may select one or more of the preconfigured playlists, stations, or channels to set as presets on the streaming music player. (Acts 130, 135, 145.) If the buyer or gift giver has an account with a streaming music service, the buyer or gift giver may log in to their account with the streaming music service and may browse their own playlists or favorite channels or stations, if any, as well as any preconfigured playlists, stations, or channels offered by the streaming music service and select one or more of their own playlists or favorite channels or stations and/or one or more of the preconfigured playlists, stations, or channels offered by the streaming music service to set as presets on the streaming music player. (Acts 130, 140, 145).

In some embodiments, the buyer or gift giver may browse a catalog of offerings (their own playlists or favorite channels or stations, if any, and/or any preconfigured playlists, stations, or channels) of the streaming music service(s) directly through the website of the retailer from which they are purchasing the streaming music player. The catalog of offerings of the streaming music service(s) may be presented in the website of the retailer in a manner such that the website maintains the looks and feel of the website of the retailer but provides a listing of streaming music playlists, stations, or channels obtained from the catalog of offerings of the streaming music service(s). For example, the webpage may retain one or more visibly perceptible elements associated with the retailer, for example, a logo, a color scheme, an image of the streaming music player, etc., while also presenting the listing of streaming music playlists, stations, or channels obtained from the catalog of offerings of the streaming music service(s) to the buyer or gift giver. In some implementations, the listing of streaming music playlists, stations, or channels may be presented without the buyer or gift giver having to select a particular streaming music service or even without the buyer or gift giver being informed of the particular streaming music service from which the listing of streaming music playlists, stations, or channels was obtained.

In some implementations, the buyer or gift giver may purchase the streaming music service subscription for the intended gift recipient without personalizing the presets of the streaming music player. In other implementations, the buyer or gift giver may personalize the presets of the streaming music player by selecting streaming music playlists, stations, or channels to associate with the presets without purchasing the streaming music service subscription for the intended gift recipient. In such implementations, the web site may inform the buyer or gift giver that the gift recipient would have to already have a subscription to the streaming music service(s) providing the selected streaming music playlists, stations, or channels or would have to purchase a subscription to the streaming music service(s) providing the selected streaming music playlists, stations, or channels prior to being able to access the selected streaming music playlists, stations, or channels. In some implementations the streaming music service(s) may provide the gift recipient with a trial subscription so that if the gift recipient does not already have an account, the gift recipient may have time to listen to the selected streaming music playlists, stations, or channels prior to deciding whether to purchase a subscription to the associated streaming music service(s).

In some implementations, information provided about the intended gift recipient may be utilized to recommend streaming music playlists, stations, or channels to the buyer or gift giver that the intended gift recipient might enjoy. For example, if the intended gift recipient is a teenager, the retailer's website might recommend streaming music playlists, stations, or channels to the buyer or gift giver that include current pop music. For older gift recipients the retailer's website might recommend streaming music playlists, stations, or channels including music that was popular when the gift recipient was in their early twenties. The recommended streaming music playlists, stations, or channels may also be selected based on the gender of the gift recipient, the region in which the gift recipient resides, or any other information available about the gift recipient.

In some implementations, the buyer or gift giver may be presented with the opportunity to enter a personal note to the intended gift recipient (act 150) to further personalize the streaming music player, for example, through a fillable form on the retailer's website. This personal note may be presented in a user interface of the streaming music player when powered on or set up by the gift recipient and/or in a user interface of a device running an application associated with the streaming music player. In act 155, the buyer or gift giver completes check out and purchase of the streaming music player, for example, by providing payment and shipping information through the retailer's website.

In some implementations, the process of purchasing the streaming music player as a gift for the gift recipient may cause an account to be created in a database of the retailer. The retailer account may include any information provided about the gift giver or gift recipient, for example, e-mail address, username (if one is selected), birthday, gender, or other demographic information, as well as information regarding whether a streaming music service subscription was purchased, and if so, which one, and information identifying any streaming music playlists, stations, or channels selected for the presets of the streaming music player and any associated streaming music services providing the selected streaming music playlists, stations, or channels. The retailer account may also include an order number associated with the purchase of the streaming music player and/or an indication of the model number of the purchased streaming music player. Further, once a particular streaming music player is associated with the order, for example, selected from inventory to fulfill the order, the serial number or other unique identifier of the particular streaming music player may be included in the retailer account.

In some implementations, if the gift recipient owns other products from the retailer, an indication of the types, model numbers, or serial numbers or other unique identifiers of the other products may also be included in the retailer account. If the gift recipient already has a retailer account, for example, created during the previous purchase of another product from the retailer, the information regarding the purchased streaming music player, the purchased streaming music subscription, if any, and the information identifying any streaming music playlists, stations, or channels selected for the presets of the streaming music player and any associated streaming music services providing the selected streaming music playlists, stations, or channels may be added to the existing retailer account of the gift recipient.

In other implementations, the retailer account is created with only limited information regarding the gift recipient, for example, age and gender and potentially e-mail address and/or name

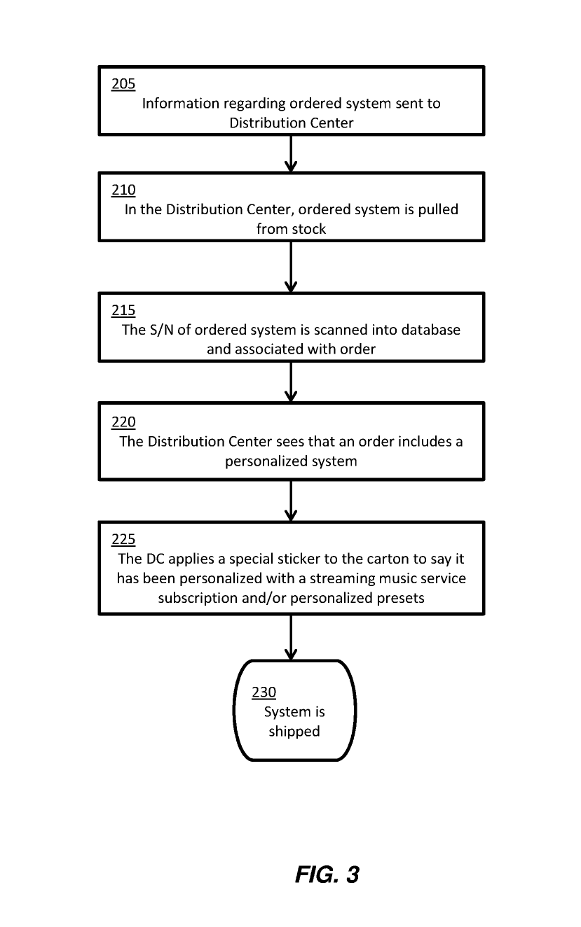

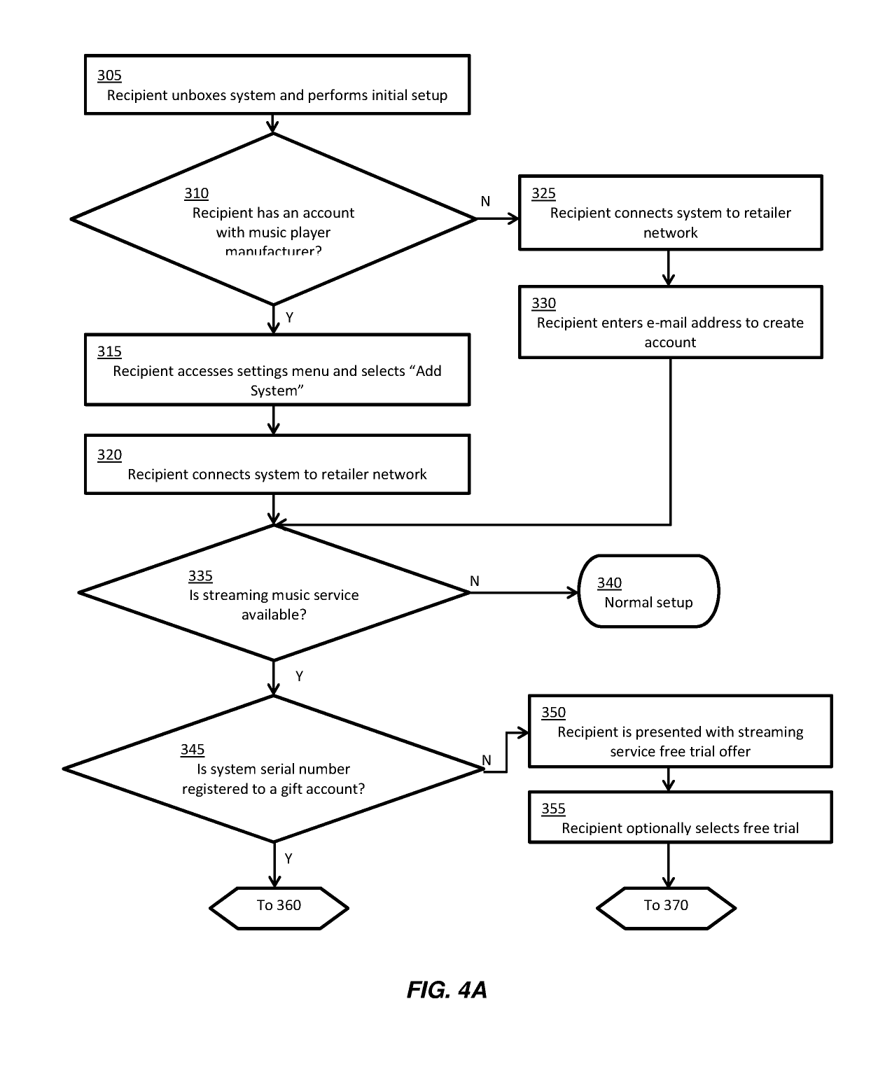

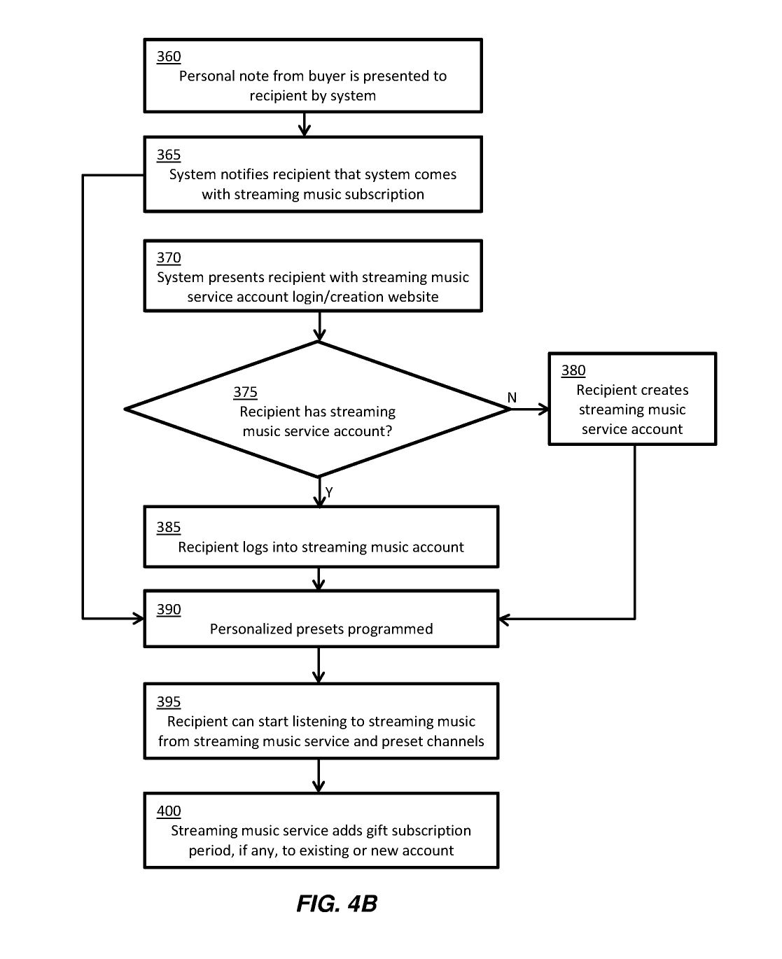

An example of a process for fulfilling an order for a gifted personalized streaming music player is illustrated in FIG. 3. In act 205 a message is sent from a computer server associated with the retailer to a distribution center associated with the retailer for a purchased streaming music player including an identification of the model of streaming music player, the shipping information for the streaming music player and any other information needed to fulfill the order for the purchased streaming music player. In some implementations, an identification of a retailer account associated with the order is sent to the distribution center and the model of streaming music player, the shipping information for the streaming music player and any other information needed to fulfill the order for the purchased streaming music player is read from the retailer account. In act 210, a streaming music player matching the streaming music player ordered is identified and pulled from stock. The serial number or other unique identifier of the streaming music player pulled from stock is identified and entered into a data base associated with the retailer and associated with the order. (Act 215.) The serial number or other unique identifier of the streaming music player pulled from stock may be added to the retailer account associated with the order. The personnel at the distribution system may be informed, for example, by referencing the retailer account associated with the order, that a streaming music service subscription has been purchased for the ordered streaming music player and/or that the ordered streaming music player has been personalized with personalized presets. A sticker or other identifying feature identifying the streaming music player as having been personalized may then be added to the package of the streaming music player and/or to the shipping carton for the streaming music player. (Act 225.) The system is then shipped to the gift recipient. (Act 230.) An example of a process for setting up a gifted streaming music player is illustrated in FIGS. 4A and 4B. In act 305, the gift recipient unboxes the streaming music player and performs initial setup, for example, by placing the system in a desired location, plugging in the system, and connecting the system to the internet, for example, by establishing a wired or wireless connection with an internet router. In act 310 a determination is made as to whether or not the gift recipient has a retailer account. In some implementations, a retailer account may have been set up for the gift recipient during purchase of the streaming music player by the buyer or gift giver, and decision act 310 (and acts 325 and 330) may be unnecessary.

If the gift recipient does not have an established retailer account, the gift recipient connects the streaming music player to the retailer's database (act 325), for example, by making an internet connection to the retailer's database. The gift recipient may connect the streaming music player to the retailer's network and/or database by, for example, following a series of prompts on the user interface of the streaming music player or in a user interface of a smart phone or computer or other device running an application associated with the streaming music player. Once the streaming music player is connected to the retailer's network and/or database, the gift recipient may create a retailer account by providing their e-mail address or other form of user name. (Act 330.)

If the gift recipient has an established retailer account, the gift recipient adds the streaming music player to their account. In some implementations, the gift recipient instructs the streaming music player to add itself to their retailer account by, for example, selecting an “Add System” or other command in the user interface of the streaming music player, a remote control associated with the streaming music player, or in the user interface of a smart phone or computer or other device running an application associated with the streaming music player. (Act 315.) The streaming music player then connects to the retailer's database (act 320), either automatically or in response to a command or commands entered by the gift recipient into the streaming music player user interface, a remote control associated with the streaming music player, or in the user interface of a smart phone or computer or other device running an application associated with the streaming music player. In some implementations, the streaming music player automatically connects to the retailer's network and/or database responsive to an internet connection being established. The streaming music player may also automatically add itself to an existing retailer account of the gift recipient by querying the retailer's database for a retailer account including the serial number or other unique identifier of the streaming music player and adding itself to the account associated with its serial number or other unique identifier.

In decision act 335 a determination is made as to whether one or more streaming music services are accessible by the streaming music player. In some implementations, the streaming music player makes the determination as to whether the one or more streaming music services are accessible by attempting to access the web sites or cloud services of the one or more streaming music services after an internet connection has been established. If the one or more streaming music services are not accessible by the streaming music player, the method proceeds to act 340 and the gift recipient continues to set up the streaming music player in a normal fashion as if no streaming music service gift subscription had been purchased by the gift giver and no personalized presets had been selected by the gift giver.

If the one or more streaming music services are accessible by the streaming music player, the method proceeds to act 345 and the streaming music player checks the retailer account for the gift recipient and determines if a streaming music service subscription had been purchased for the streaming music player.

If in decision act 345 it is determine that a streaming music service subscription had been purchased for the streaming music player, the method proceed to act 360 and the personal message, if any, entered by the buyer or gift giver during purchasing of the streaming music player is displayed in the user interface of the streaming music player and/or in the user interface of a smart phone or computer or other device running an application associated with the streaming music player and/or is played through the speakers of the streaming music player. In some implementations, the personal message may be displayed even if no streaming music service subscription had been purchased for the streaming music player. In act 365, the streaming music player informs the gift recipient that a streaming music service subscription had been purchased for the streaming music player by, for example, presenting a message in the user interface of the streaming music player or in a user interface of a smart phone or computer or other device running an application associated with the streaming music player and/or by playing a message through the speakers of the streaming music player. The streaming music player informs the gift recipient of what streaming music service (or services) the subscription is for and the duration of the gift subscription.

The streaming music player accesses the retailer account for the gift recipient and determines which, if any, personalized pre-set had been selected by the buyer or gift giver and assigns these personalized presets to the presets of the streaming music player. (Act 390.) In some implementations, the streaming music player may access the retailer account for the gift recipient, identify any personalized pre-set that had been selected by the buyer or gift giver and/or assign these personalized presets to the presets of the streaming music player at another point in the method, for example, when determining if a streaming music service subscription had been purchased for the streaming music player in act 345. The gift recipient can start listening to streaming music from the streaming music service(s) and utilize the preset selectors on the streaming music player to access the personalized presets. (Act 395.) The period of the streaming music gift subscription(s), if any, are set for the newly created streaming music service account(s) or the period of the streaming music gift subscription(s), if any, are added to the remaining term of existing streaming music service subscription(s) of the gift recipient. (Act 400.)

If no streaming music service subscription had been purchased for the streaming music player the method proceeds to act 350 and the gift recipient is presented with the option of signing up for a free trial of one or more streaming music services. The gift recipient may accept the free trial offer in act 355. In some instances, the gift recipient may already have a subscription to the one or more streaming music services and thus may decline the free trial offer and the method may proceed to act 370. In act 370 the streaming music player and/or the user interface of a smart phone or computer or other device running an application associated with the streaming music player presents the gift recipient with the account login/account creation website(s) of a streaming music service (or services). This website may be presented in the user interface of the streaming music player or in the user interface of a smart phone or computer or other device running an application associated with the streaming music player. In other implementations, the gift recipient manually accesses the account login/account creation website(s) of the streaming music service (or services). If the gift recipient does not have an existing account with the streaming music service (or services) (decision act 375), the gift recipient may create an account (or accounts) in act 380. If the gift recipient does have an existing account with the streaming music service (or services) (decision act 375), the gift recipient may log in to their account (or accounts) in act 385. Once the gift recipient has logged into their previously existing or newly created streaming music service account(s), any streaming music playlists, stations, or channels selected by the buyer or gift giver are programmed as presets in the streaming music player. The streaming music player may access the retailer account created for the gift recipient to obtain an indication of which, if any, streaming music playlists, stations, or channels were selected by the buyer or gift giver as presets for the streaming music player anytime during setup of the streaming music player, for example, in act 345 where the streaming music player checks if a streaming music gift subscription had been purchased for the streaming music player, or after the gift recipient created or logged into the associated streaming music service(s).

The gift recipient can start listening to streaming music from the streaming music service(s) and utilize the preset selectors on the streaming music player to access the personalized presets. (Act 395.) The period of the streaming music gift subscription(s), if any, are set for the newly created streaming music service account(s) or the period of the streaming music gift subscription(s), if any, are added to the remaining term of existing streaming music service subscription(s) of the gift recipient. (Act 400.)

It is to be understood that although the methods described above refer to the purchase and setup of a single streaming music player, these methods may be equally applicable to the purchase of multiple streaming music players by a buyer or gift giver for a single or multiple gift recipients. The same or different options for purchased streaming music subscriptions and/or selected presets may be applied to the multiple purchased streaming music players.

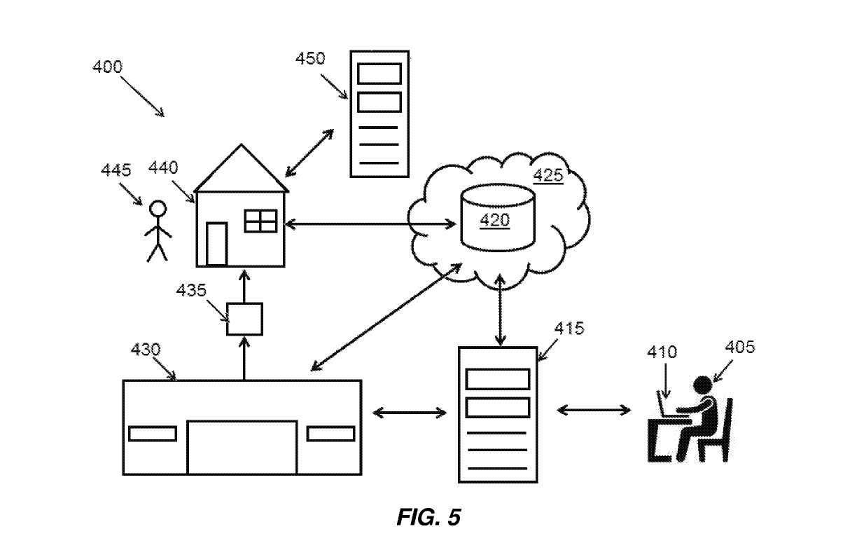

An example of an environment in which the aspects and implementations disclosed herein may be practiced is illustrated in FIG. 5 and indicated generally by reference numeral 400. A buyer or gift giver 405 may access the website of a retailer for a streaming music player utilizing a computer, smart phone, or other computing device 410. The buyer or gift giver 405 may access the website of the retailer by accessing a computer server 415 associated with the retailer and hosting the website over an internet connection. As described with reference to the method of FIGS. 2A and 2B, during the process of purchasing a streaming music player for a gift recipient, the buyer or gift giver 405 may provide information about the gift recipient to the retailer via the website of the retailer. The information about the gift recipient may be used by the retailer to create a retailer account for the gift giver. The retailer account information may be stored in the server 415 or in a database 420 located in the cloud 425. Information regarding any streaming music subscriptions purchased by the buyer or gift giver for the gift recipient, information regarding any playlists, stations, or channels selected by the buyer or gift giver to assign as presets to the streaming music player purchased for the gift recipient, and information identifying the streaming music player purchased for the gift recipient (e.g., the serial number or other unique identifier of the system) may also be included in the retailer account for the gift recipient.

After a streaming music player has been purchased information about the purchased streaming music player is sent to a distribution center 430 which fulfills the order. The distribution center 430 may receive information regarding personalization or the purchase of a gift music streaming service subscription and information regarding the gift recipient, for example, the address of the gift recipient from server 415 and/or from the retailer account for the gift recipient.

The distribution center 430 ships the streaming music player 435 to the gift recipient, for example, to a residence 440 or place of employment of the gift recipient 445. The gift recipient 445 sets up the streaming music player 435 during which time the streaming music player 435 accesses the retailer account for the gift recipient to determine if a streaming music service gift subscription should be set up for the gift recipient and/or how to set the presets of the streaming music player 435. The gift recipient 445 may then use the streaming music player 435 to stream music from a streaming music service provider through the internet from a server 450 associated with the streaming music service provider of from a database in the cloud 425.

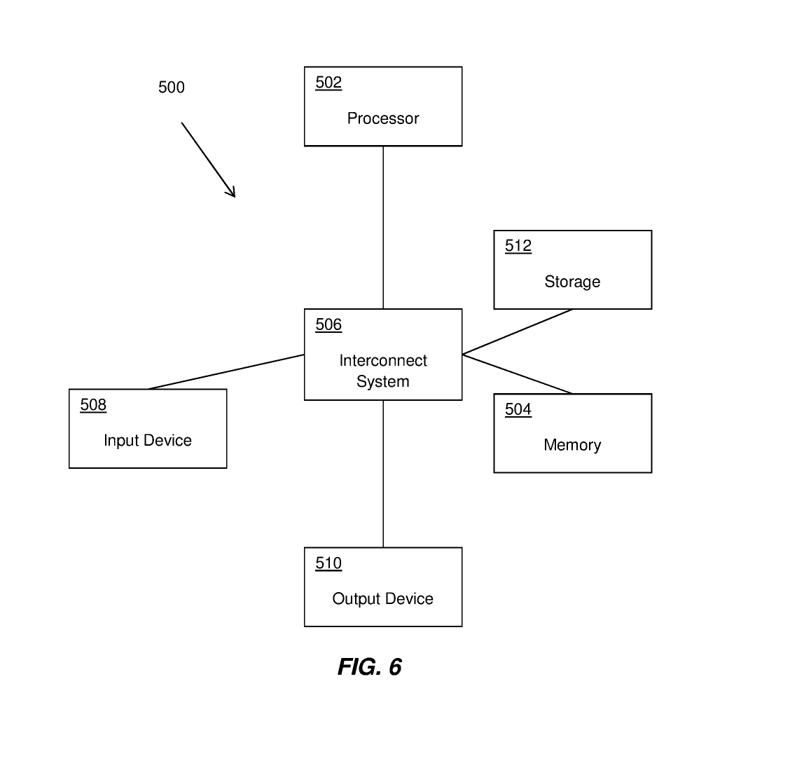

The various computer systems disclosed herein, for example, server 415 or server 450 may include specialized software executing in a general-purpose computer system 500 such as that shown in FIG. 6. The computer system 500 may include a processor 502 connected to one or more memory devices 504, such as a disk drive, solid state memory, or other non-transitory recording medium for storing data. Memory 504 is typically used for storing programs and data during operation of the computer system 500. Components of computer system 500 may be coupled by an interconnection mechanism 506, which may include one or more busses (e.g., between components that are integrated within a same machine) and/or a network (e.g., between components that reside on separate discrete machines). The interconnection mechanism 506 enables communications (e.g., data, instructions) to be exchanged between system components of system 500. Computer system 500 also includes one or more input devices 508, for example, a keyboard, mouse, trackball, microphone, touch screen, and one or more output devices 510, for example, a printing device, display screen, and/or speaker.

The computer system may include specially-programmed, special-purpose hardware, for example, an application-specific integrated circuit (ASIC). Aspects and embodiments disclosed herein may be implemented in software, hardware or firmware, or any combination thereof. Further, such methods, acts, systems, system elements and components thereof may be implemented as part of the computer system described above or as an independent component.

Although computer system 500 is shown by way of example as one type of computer system upon which various aspects and embodiments disclosed herein may be practiced, it should be appreciated that aspects and implementations disclosed herein are not limited to being implemented on the computer system as shown in FIG. 6. Various aspects and implementations disclosed herein may be practiced on one or more computers having a different architecture or components than shown in FIG. 6.

Computer system 500 may be a general-purpose computer system that is programmable using a high-level computer programming language. Computer system 500 may be also implemented using specially programmed, special purpose hardware. In computer system 500, processor 502 is typically a commercially available processor such as the well-known Pentium™ or Core™ class processors available from the Intel Corporation. Many other processors are available, including programmable logic controllers. Such a processor usually executes an operating system which may be, for example, the Windows 7, Windows 8, or Windows 10 operating system available from the Microsoft Corporation, the MAC OS System X available from Apple Computer, the Solaris Operating System available from Sun Microsystems, or UNIX available from various sources. Many other operating systems may be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects and embodiments disclosed herein may be performed on a client-server system that includes components distributed among one or more server systems that perform various functions according to various aspects and embodiments disclosed herein. These components may be executable, intermediate (e.g., IL) or interpreted (e.g., Java) code which communicate over a communication network (e.g., the Internet) using a communication protocol (e.g., TCP/IP). In some embodiments one or more components of the computer system 500 may communicate with one or more other components over a wireless network, including, for example, a cellular telephone network.

It should be appreciated that the aspects and implementations disclosed herein are not limited to executing on any particular system or group of systems. Also, it should be appreciated that the aspects and implementations disclosed herein are not limited to any particular distributed architecture, network, or communication protocol. Various aspects and implementations disclosed herein are may be programmed using an object-oriented programming language, such as SmallTalk, Java, C++, Ada, or C# (C-Sharp). Other object-oriented programming languages may also be used. Alternatively, functional, scripting, and/or logical programming languages may be used, for example, ladder logic. Various aspects and implementations disclosed herein may be implemented in a non-programmed environment (e.g., documents created in HTML, XML or other format that, when viewed in a window of a browser program, render aspects of a graphical-user interface (GUI) or perform other functions). Various aspects and implementations s disclosed herein may be implemented as programmed or non-programmed elements, or any combination thereof.

Having thus described several aspects of at least one implementation, it is to be appreciated various alterations, modifications, and improvements will readily occur to those skilled in the art. Such alterations, modifications, and improvements are intended to be part of this disclosure, and are intended to be within the spirit and scope of the disclosure. The acts of methods disclosed herein may be performed in alternate orders than illustrated, and one or more acts may be omitted, substituted, or added. One or more features of any one example disclosed herein may be combined with or substituted for one or more features of any other example disclosed. Accordingly, the foregoing description and drawings are by way of example only.

The phraseology and terminology used herein is for the purpose of description and should not be regarded as limiting. As used herein, the term “plurality” refers to two or more items or components. As used herein, dimensions which are described as being “substantially similar” should be considered to be within about 25% of one another. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A computer system comprising a processor and a non-transitory computer readable memory including instructions that when executed by the processor cause the computer system to:
receive a request from a gift giver to purchase a streaming music player for a gift recipient;
present the gift giver with at least one streaming audio channel;
receive a selection by the gift giver of one or more streaming audio channels to assign to one or more respective preset selectors of the streaming music player; and
send instructions to assign the one or more streaming audio channels to the one or more respective preset selectors of the streaming music player, based on the selection received from the gift giver.

2. The system of claim 1, wherein the instructions, when executed by the processor, further cause the computer system to:
receive a request from the gift giver to purchase a streaming music service subscription for use with the streaming music player for the gift receiver; and
request that a streaming music service provider add a duration of the streaming music service subscription to a streaming music service subscription of the gift receiver.

3. The system of claim 2, wherein the instructions, when executed by the processor, further cause the computer system to receive demographic information regarding the gift receiver and to instruct a streaming music service provider of a streaming music service associated with the streaming music service subscription to provide recommended streaming audio channels in the list of streaming audio channels, the recommended streaming audio channels selected based on the demographic information regarding the gift receiver.

4. The system of claim 1, wherein the instructions, when executed by the processor, further cause the computer system to present the gift giver with a list of streaming audio channels by:
identifying a source of streaming audio channels; and
presenting a listing of streaming audio channels from the source of streaming audio channels in a composite web page having a look and feel of a host web page of the retailer.

5. The system of claim 4, wherein the instructions, when executed by the processor, further cause the computer system to present a plurality of visibly perceptible elements in the composite web page, the plurality of visibly perceptible elements being substantially similar to a plurality of visibly perceptible elements presented on the host web page of the retailer.

6. The system of claim 1, wherein the instructions, when executed by the processor, further cause the computer system to receive an indication from the gift giver of an age and a gender of the gift receiver and to create a retailer account for the gift receiver including an indication of the age of the gift receiver and an indication of the gender of the gift receiver.

7. The system of claim 6, wherein the instructions, when executed by the processor, further cause the computer system to include an indication of the one or more streaming audio channels selected by the gift giver in the retailer account for the gift receiver.

8. The system of claim 7, wherein the streaming music player is configured to assign the one or more streaming audio channels to the one or more respective preset selectors by a method including accessing the indication of the one or more streaming audio channels selected by the gift giver in the retailer account for the gift receiver.

9. The system of claim 1, wherein the computer system is further configured to receive an indication of a unique identifier of the streaming music player and add the unique identifier to a retailer account of the gift receiver.

10. The system of claim 10, wherein the unique identifier is a serial number of the streaming music player

11. The system of claim 1, wherein the instructions, when executed by the processor, further cause the computer system to:
receive a request from the gift giver to purchase a streaming music service subscription for use with the streaming music player for the gift receiver; and
request that a streaming music service provider create a streaming music service subscription for the gift receiver.

12. A method comprising:
receiving, at a computer system of a retailer, a request from a gift giver to purchase a streaming music player for a gift recipient;
sending a list of streaming audio channels to the gift giver;
receiving, at the computer system of the retailer, a selection by the gift giver of one or more streaming audio channels from the list of streaming audio channels to assign to one or more respective preset selectors of the streaming music player; and
sending instructions to assign the one or more streaming audio channels to the one or more respective preset selectors of the streaming music player.

13. The method of claim 12, further comprising receiving, at the computer system of the retailer, a request from the gift giver to purchase a streaming music service subscription for use with the streaming music player for the gift receiver.

14. The method of claim 13, further comprising requesting that a streaming music service provider of a streaming music service associated with the streaming music service subscription add a duration of the streaming music service subscription to an existing streaming music service subscription of the gift receiver.

15. The method of claim 13, further comprising, receiving, at the computer system of the retailer, demographic information regarding the gift receiver and instructing a streaming music service provider of a streaming music service associated with the streaming music service subscription to provide recommended streaming audio channels in the list of streaming audio channels, the recommended streaming audio channels selected based on the demographic information regarding the gift receiver.

16. The method of claim 12, wherein presenting the gift giver with the list of streaming audio channels comprises:
identifying a source of streaming audio channels; and
presenting a listing of streaming audio channels from the source of streaming audio channels in a composite web page having a look and feel of a host web page of the retailer.

17. The method of claim 16, further comprising presenting a plurality of visibly perceptible elements in the composite web page, the plurality of visibly perceptible elements being substantially similar to a plurality of visibly perceptible elements presented on the host web page of the retailer.

18. The method of claim 12, further comprising, receiving, at the computer system of the retailer, an indication from the gift giver of an age and a gender of the gift receiver and creating a retailer account for the gift receiver including an indication of the age of the gift receiver and an indication of the gender of the gift receiver.

19. The method of claim 18, further comprising including an indication of the one or more streaming audio channels selected by the gift giver in the retailer account for the gift receiver.

20. The method of claim 19, wherein assigning the one or more streaming audio channels to the one or more respective preset selectors of the streaming music player includes the streaming music player accessing the indication of the one or more streaming audio channels selected by the gift giver in the retailer account for the gift receiver.

21. The method of claim 19, wherein the streaming music player identifies the retailer account for the gift receiver by matching a unique identifier of the streaming music player with an indication of a unique identifier included in the retailer account for the gift receiver.

22. A streaming music player comprising:
a processor;
a network interface operatively coupled to the processor and configured to access streaming audio content from one or more streaming audio content sources;
an electro-acoustic transducer operatively coupled to the processor;
a plurality of preset indicators operatively coupled to the processor, each of the plurality of preset indicators configured to initiate streaming and rendering of content from an assigned audio channel from one of the streaming audio content sources through the electro-acoustic transducer; and
a memory operatively coupled to the processor, the memory including programming which when executed by the processor causes the processor to access a cloud-based database including account information associated with the streaming music player including a set of user-defined audio channel presets associated with a unique identifier of the streaming music player and to assign the user-defined audio channel presets to the plurality of preset indicators.

23. The streaming music player of claim 22, wherein the plurality of preset indicators are presented on one of a remote control for the streaming music player or a computing device running an application associated with the streaming music player.
